(19) United States
(12) Patent Application Publication
(10) Pub. No.: US 2018/0066928 A1
(43) Pub. Date: Mar. 8, 2018

(54) SYSTEM FOR CHECKING DIMENSIONAL AND/OR GEOMETRIC FEATURES OF WORKPIECES, AND RELATIVE PROCEDURE FOR MANUFACTURING

(71) Applicant: Marposs Societa' Per Azioni, Bentivoglio (BO) (IT)

(72) Inventors: Alessandro Santini, Rochester Hills, MI (US); Giacomo Govoni, Poggio Renatico (FE) (IT)

(73) Assignee: Marposs Societa' Per Azioni, Bentivoglio (BO) (IT)

(21) Appl. No.: 15/553,862

(22) PCT Filed: Feb. 24, 2016
(86) PCT No.: PCT/EP2016/053880

§ 371 Date: Aug. 25, 2017

(30) Foreign Application Priority Data
Feb. 26, 2015 (IT) BO2015A000100

(51) Int. Cl. G01B 7/012; G01B 1/00

(52) U.S. Cl. CPC G01B 7/012; G01B 1/00

(57) ABSTRACT

A checking system (4) for checking dimensional and/or geometric features of a workpiece (W) comprises a support and locating element (30), a feeler (50) for touching the workpiece, an arm (42) supporting the feeler and movable with respect to the support and locating element, and a transducer device (14) to detect the position of a checking surface (41) of the arm with respect to the support and locating element and generate signals indicative of the features to be checked. At least one of the support and locating element and the arm is made of a material having density not higher than 1.6 g/cm3 and tensile strength not lower than 1.3 GPa. A procedure for manufacturing such checking system comprises the steps of obtaining a plurality of flat elements from a sheet of material having the aforementioned characteristics, and connecting the flat elements to obtain box-like structures that define at least one of the support and locating element and the arm. The apparatus can be advantageously applied for high speed checking shape or profile of rotating workpieces.

### TECHNICAL FIELD

The present invention relates to a system for checking dimensional and/or geometric features of a workpiece, comprising: a support and locating element, a feeler for touching the workpiece to be checked, a transmission assembly comprising an arm supporting the feeler and movable with respect to the support and locating element, and a transducer device designated to cooperate with the transmission assembly to detect the position of a checking surface of the arm with respect to the support and locating element and generate corresponding signals indicative of the dimensional and/or geometric features of the workpiece.

The invention also relates to a procedure for manufacturing a checking system with a support and locating element and an arm, movable with respect to the support and locating element, comprising the steps of arranging a sheet of material having density not higher than 1.6 g/cm³ and tensile strength not lower than 1.3 GPa, obtaining a plurality of flat elements from said sheet of material, and connecting said flat elements one to the other to obtain box-like structures with substantially rectangular hollow section that define at least one of the support and locating element and the arm.

The present invention can be advantageously but not exclusively applied to the precision and high speed check of shape or profile of rotating workpieces mechanical manufactured with a tool, for example grinded with a grinder, that show small and frequent superficial undulations due to said mechanical manufacturing, which the following specification will explicitly refers to without loss of generality.

### PRIOR ART

Apparatuses for checking geometric features of workpieces, in particular for checking the surfaces shape of rotating pieces, are known and broadly widespread in the market.

Generally, the known apparatuses comprise a system for measuring or checking, with a support and locating element, a feeler apt to touch a rotating workpiece to be checked, a transmission assembly with a fulcrum that allows movements of the feeler with respect to the support and locating element, and a transducer device to detect the position of the feeler with respect to the support and locating element and provide a signal indicative of the dimensions of the workpiece. For example, in the European patent number EP0946854B1, owned by the applicant of the present application, a system for checking linear dimensions of workpieces is described, with an integral element that defines an arm to support a feeler, a reference portion and a fulcrum that allows rotations or flexures of the arm with respect to the reference portion, and a transducer device to provide signals indicative of the position of the feeler with respect to the reference portion. The integral element is made by means of a single U-bended strap of stainless steel sheet, later undergone to deep-drawing in one point wherein a very thin and soft fulcrum is obtained. As a consequence, a lightweight system featuring low measuring force results. In an operative phase, the arm, through the flexures in the fulcrum, maintains the feeler in contact with the rotating workpiece. Since the measuring force is low, the feeler follows the profile of the workpiece, the workpiece is not damaged, for example sagged and/or scratched, even when it is structurally weak and/or made of soft material, and the transducer detects the position of the feeler with respect to the reference portion and provides a signal indicative of said profile.

However, this system may show some problem in the precision and high speed check or measurement of dimensions and shape of pieces with common systemic shape errors that may arise, for example, during the grinding procedures. If the grinding wheel of the grinder, indeed, is not perfectly balanced, while rotating, it is consequently subject to regular vibrations that are known in literature with the name of chatter. Due to such vibrations, in a phase of manufacturing a workpiece, superficial undulations with amplitude up to 50 nm are created on the whole profile of the piece, that alter the shape of the latter. In a phase of checking the manufactured workpiece, when the feeler touches the rotating piece and runs across for example a rise front of a superficial undulation due to the chatter, the feeler is subjected to an impulsive force proportional to the rotational speed of the piece, which impulsive force moves the feeler away from the profile of the rotating piece. Despite its duration limited in time, this impulsive force is usually higher than the low measuring force of the described system, hence the feeler takes a certain time to reverse the moving away motion and touch back the rotating workpiece, probably bouncing on the latter at least once, during which the system detects an incorrect measurement of the profile features.

### DISCLOSURE OF THE INVENTION

Object of the present invention is to provide an extremely accurate and reliable system for checking or measuring dimensional and/or geometric features of workpieces, for example for checking the shape of a rotating surface, which system has simple structure, can be easily and cheaply implemented, goes beyond the limits of the known checking system and can be used in precision apparatuses that work at high speed.

These and other objects are achieved by a checking system according to claim 1.

An important advantage obtained through a checking system according to the present invention and through an apparatus comprising one or more of said checking systems consists in the possibility of performing, with extremely reliable results, precision and high speed check or measurement of rotating workpieces that may show superficial undulations due to the mechanical manufacturing.

A further object of the present invention is to obtain an accurate and reliable checking system through a simple, fast and economic procedure for manufacturing.

These and other objects are achieved by a procedure for manufacturing according to claim 17.

Further objects and advantages of the present invention will be clear from the detailed description that follows.

### BRIEF DESCRIPTION OF THE DRAWINGS

The present invention is now described with reference to the attached sheets of drawings, given by way of non-limiting examples, wherein:

FIG. 1 is a schematic view of an apparatus with a system according to the present invention, very simplified and with parts removed for clarity, for checking dimensional and geometric feature of a workpiece;

FIG. 2 is an enlargement of FIG. 1, that shows in a more detailed but however schematic way the checking system according to the present invention; and

FIG. 3 is an enlarged section along line III-III of a detail of the checking system in FIG. 2.

### BEST MODE FOR CARRYING OUT THE INVENTION

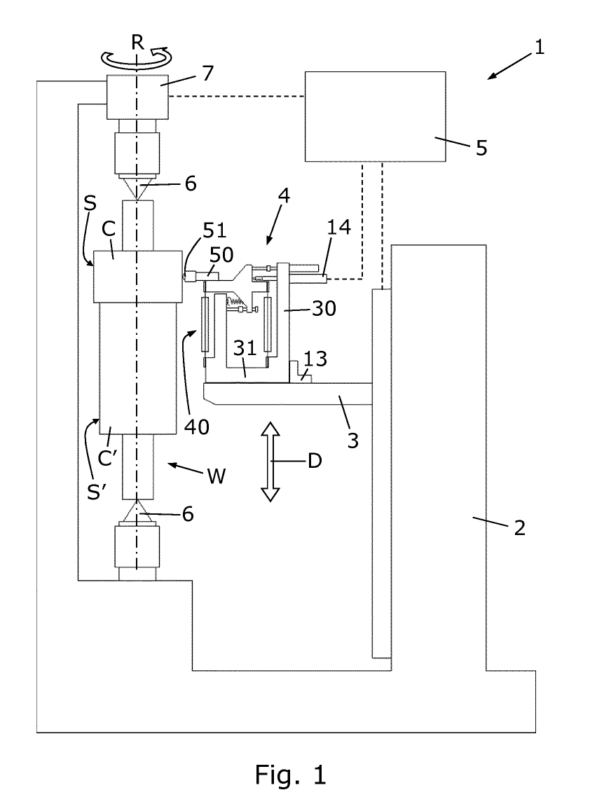

FIG. 1 is a schematic view of an apparatus 1 for checking dimensional and/or geometric features of a workpiece W, in particular for checking the shape of a surface S of a component C of the workpiece W. The apparatus 1 comprises a frame 2, support and rotation means 6 designed to refer with precision and rotate the workpiece W, consequently the component C, about a rotation axis R, a measurement slide 3 apt to carry out translation movements in both ways of a main direction D parallel to the rotation axis R, and a processing unit 5 apt to send control signals to the measurement slide 3 to control said translation movements. In addition, the apparatus 1 includes at least a checking system or measurement cell 4, for checking and/or measuring dimensional and/or geometric features of the workpiece W. In the apparatus 1, for instance, the measurement cell 4 is designed to be coupled to the measurement slide 3 in order to be moved along the main direction D. In more detail, the measurement cell 4 comprises a support and locating element 30 with a base 31 rigidly connected and conveniently referred to the measurement slide 3 by means of known elements schematically represented with an abutment 13.

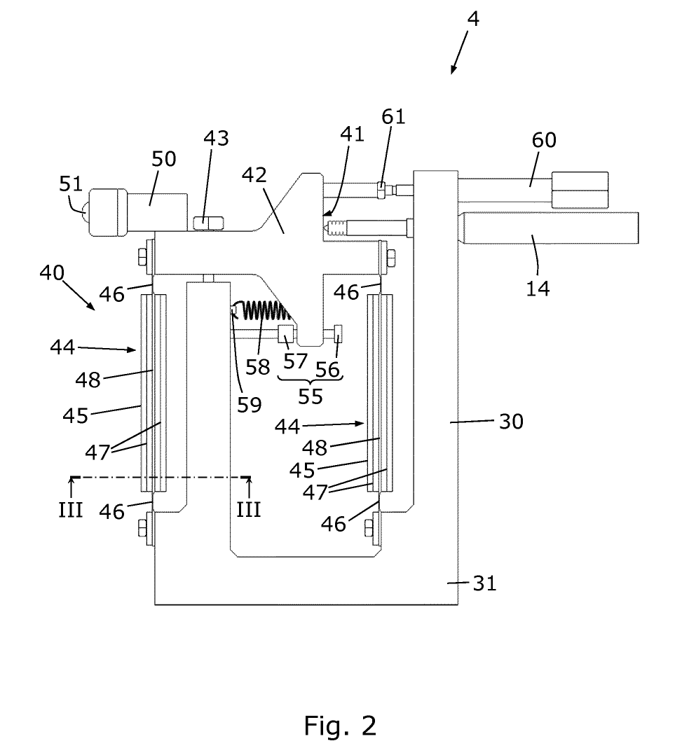

The measurement cell 4 according to the present invention also comprises a feeler 50 with a contacting element, a contacting sphere 51 in FIG. 1, for touching the workpiece W to be checked, in particular the surface S of the component C, and a transmission assembly 40. The measurement cell 4 also comprises an arm 42 supporting the feeler 50 and movable with respect to the support and locating element 30, allowing movements of the feeler 50 along a measurement direction due to the variation of the radial dimensions of the component C which the contacting sphere 51 abuts against. With reference to FIG. 2, the feeler 50 is rigidly connected to the arm 42, in such a way that the position of the arm 42, more specifically of a checking surface 41 of the latter, with respect to the support and locating element 30 is linearly dependent on the position of said feeler 50.

A transducer device 14 of the measurement cell 4, for example a “pencil”-like head with axial movement, that is shown connected to the support and locating element 30 in figure, is able to detect the position of the feeler 50 with respect to the support and locating element 30 and generate corresponding signals indicative of the dimensional and/or geometric features of the component C of the workpiece W. In particular, the transducer device 14 is designed to cooperate with the transmission assembly 40, for example it has a movable part in contact with the checking surface 41 of the arm 42, to detect the position of the latter, and consequently of the feeler 50, with respect to the support and locating element 30, and send the corresponding signals to the processing unit 5.

The transducer device 14 is also connected to the processing unit 5 that receives and processes the signals generated by the measurement cell 4 in order to check or measure said features. The processing unit is also connected to a unit known per se and schematically represented with the reference 7, that sends signals indicative of the angular position of the workpiece W and then of the component C during the respective rotation.

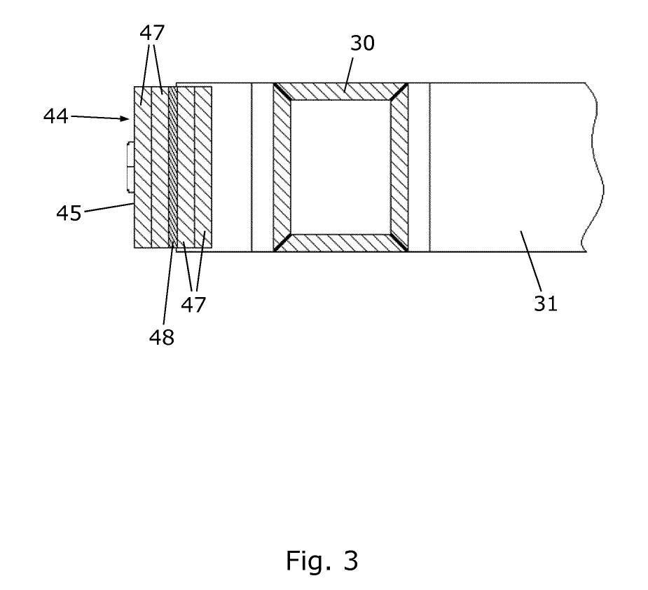

At least one of the support and locating element 30 and the arm 42, preferably both of them, is box-like, that is it has a structure with substantially rectangular hollow section, as shown in FIG. 3. In particular, such structure is defined by means of a plurality of flat elements connected one to the other, preferably glued at connection edges. The flat elements are made of a material having density not higher than 1.6 g/cm³ (therefore more lightweight than steel, which has density equal to about 7.7 g/cm³), and high tensile strength, for example not lower than 1.3 GPa, such as for instance a carbon fibre composite material. Said flat elements can be advantageously obtained from one sheet of material, for example cut by means of water jet technology, with production costs and times notably inferior to those of a printed element. As a consequence, the support and locating element 30 and/or the arm 42 result to be robust and lightweight at the same time.

The transmission assembly 40 comprises also two connection struts 44 between the arm 42 and the support and locating element 30, in particular the base 31. Each of the two connection struts 44 includes a flat and stiff portion 45 and two elastic portions that define a fulcrum 46, for example, at each of two opposed connection ends to the base 31 and to the arm 42. The connection struts 44 are suitably arranged parallel one to the other. As a consequence, the base 31 of the support and locating element 30 and the arm 42, that also result aligned on directions parallel one to the other, together with the two connection struts 44 form a flexible parallelogram structure provided with fulcra 46, apt to allow movements of the arm 42, hence of the feeler 50, with respect to the support and locating element 30, along the measurement direction.

Each of the two connection struts 44 preferably comprises a lamina 48 made of a material with density not higher than 4.4 g/cm³ (therefore more lightweight than steel, that has density equal to about 7.7 g/cm³, as already said), tensile strength not lower than 1000 MPa, and modulus of elasticity not higher than 110 GPa (that is less stiff than steel, whose modulus of elasticity is about 210 GPa), for example a titanium alloy. In this case, the flat and stiff portion 45 is obtained by coupling, preferably gluing, backing elements 47, for example carbon fibres composite material plates, to the lamina 48, in a central zone not comprising the two elastic portions that define the fulcra 46 at the connection ends. Also the backing elements 47 can be advantageously obtained, for example cut by means of water jet technology, from said one sheet of material which the flat elements are obtained from, with the already mentioned advantages. Thanks also to the characteristics of the material of the laminae 48, the flexible parallelogram structure is characterized by a high capability of warping, in particular bending, when it undergoes a force, and rapidly going back to the previous position when the force that caused its deformation ceases.

Basically, the position of the checking surface 41 of the arm 42 depends in a nonlinear way also on the movements of the arm 42 along directions different from the measurement one, as a function of the flexures of the parallelogram, more exactly the flexures of the elastic portions of the connection struts 44 that define the fulcra 46. With respect to the support and locating element 30, indeed, the arm 42 carries out movements along a trajectory that can be ideally assimilated to a circular arc. The corresponding signal that the head 14 in contact with the checking surface 41 sends to the processing unit 5, comprises therefore a linear component, dependent on the position of the feeler 50 along the measurement direction, and a nonlinear, undesired component. In order to get correct information about dimensions and shape of said component C, when the contacting sphere 51 touches the surface S of the component C, it is advantageous that the processing unit 5 executes an appropriate compensation algorithm to remove the nonlinear component from the signals received from the head 14.

The transmission assembly 40 includes a limitation mechanism 55, connected to the support and locating element 30, which comprises a first abutment element 56 and a second abutment element 57 apt to cooperate with the arm 42 in order to limit its movements, and consequently limit the flexure of the parallelogram, thus preventing the damage of the fulcra 46. In more detail, the first abutment element 56 limits the over-stroke of the arm 42, whereas the second abutment element 57 limits the pre-stroke of the latter.

A tension spring 58 refers to the arm 42 on the one part and to a connection element 59 connected to the support and locating element 30 on the other, to urge the feeler 50, in particular the contacting sphere 51, towards the component C of the workpiece W. This tension spring 58 is preferably adjustable, to set the pressure that the contacting sphere 51 applies on the surface S of the component C to be checked.

A locking element or pin 43 is apt to cooperate with the transmission assembly 40 in order to block it in a static configuration, wherein for example the laminae 48 are not bent, in particular during transport operations or maintenance works. For instance, the locking pin 43 may be inserted in an opening of the arm 42 for fastening the latter to the support and locating element 30, in order to prevent whichever flexure of the parallelogram structure. In the static configuration, the transmission assembly 40 is safeguarded from possible collisions or inaccurate handling that could damage or break some components or the whole transmission assembly 40.

The measurement cell 4 also comprises a retraction device 60, for example a pneumatic cylinder, connected to the support and locating element 30. The pneumatic cylinder 4 is apt to receive control signals from the processing unit 5 in order to cooperate with the transmission assembly 40, for example pull the arm 42 up to the contact with the first abutment element 56 by overcoming the force of the tension spring 58, and bring the measurement cell 4 in a retraction state, wherein the parallelogram structure is bent and, if the workpiece W is arranged in the support and rotation means 6, the contacting sphere 51 is at a certain distance from the surface of the component C. The pneumatic cylinder 60 is advantageously equipped with an adjusting element or nut 61 apt to cooperate with the support and locating element 30 to adjust the stroke of the pneumatic cylinder 60 with respect to the transmission assembly 40.

The operation of the apparatus 1 is described in the following, for example for checking the shape and/or the profile of a surface S of a component C of a workpiece W, where the surface S features small and frequent undulations due to the mechanical manufacturing.

In case of inactivity, the locking pin 43 is inserted in the opening of the arm 42, in order to fasten the latter to the support and locating element 30. Consequently, the transmission assembly 40 is blocked in the static configuration wherein whichever flexure of the parallelogram structure is prevented. In order to perform checking operations with the apparatus 1, the locking pin 43 must be removed from the opening of the arm 42 so that the parallelogram structure is free to bend.

Conveniently, a calibration procedure may be initially executed by checking a master, that is a sample piece that comprises a surface having a reference profile that corresponds to the nominal profile of the surface S of the component C to be checked. The master is arranged in and referred to the support and rotation means 6 of the apparatus 1 and rotated about the rotation axis R, so that the surface with the reference profile is located, while rotating, at a height that is known a priori.

In an initial phase, the pneumatic cylinder 60 receives the control signal from the processing unit 5, to pull the arm 42 up to the contact with the first abutment element 56 by overcoming the force of the tension spring 58, so that the measurement cell 4 is brought in the previously described retraction state. As the base 31 is referred and rigidly connected to the measurement slide 3, the latter, conveniently controlled by the processing unit 5, moves the measurement cell 4, that is retracted, along the main direction D, until the contacting sphere 51 is brought at the known height of the reference surface of the master.

In a detection phase, the pneumatic cylinder 60, controlled by the processing unit 5, releases the arm 42, and the contacting sphere 51 of the feeler 50, under the action of the tension spring 58, is urged against the reference surface. At this point, the tension spring 58 is conveniently adjusted to set the pressure that the contacting sphere 51 exercises on the master so that the feeler follows the profile of the latter, and then of the component C, without damaging them. The head 14, as it is in contact with the checking surface 41 of the arm 42, generates signals indicative of the position of the feeler 50 along the measurement direction. The processing unit 5 detects such signals for at least one rotation of the master and processes them in a known way with information concerning the rotation, in particular the angular position of the master, to obtain and store, in a way known per se, the reference profile which the following measurements are compared with.

The procedure for checking the shape, and possibly the dimensions, of the surface S of the component C occurs at the end of the calibration.

In particular, in a new initial phase, the measurement cell 4 is brought in the retraction state by the pneumatic cylinder 60, as previously described, wherein the contacting sphere 51 does not touch the reference surface, so that the master can be removed from the apparatus 1. The workpiece W is arranged in and referred to the support and rotation means 6 of the apparatus 1 and rotated about the rotation axis R, so that the surface S of the component C to be checked is located, while rotating, at the above-mentioned height that is known a priori.

In a subsequent detection phase, the pneumatic cylinder 60, controlled by the processing unit 5, releases the arm 42, and the contacting sphere 51 of the feeler 50, under the action of the tension spring 58, is consequently urged against the surface S. The head 14, as it is in contact with the checking surface 41 of the arm 42, generates signals indicative of the position of the feeler 50 along the measurement direction. The processing unit 5 detects such signals for at least one rotation of the workpiece W, processes them in a known way with information concerning the rotation, in particular the angular position, of the workpiece W, and compares the result of the processing relative to the profile of the surface S of the component C and the reference profile stored during the calibration procedure, in order to verify whether the real profile matches or not with the reference profile for less than predetermined tolerances and/or to detect shape errors of the checked surface S, for example the frequency and the entity of the superficial undulations previously cited.

When the contacting sphere 51, during the scan of the surface S over the rotation of the component C, runs across a rise front of one of the superficial undulations, it is subjected to an impulsive force proportional to the rotational speed of said component C, that moves the contacting sphere 51 away from the surface S being checked. By advantageously combining the lightness and robustness characteristics of the arm 42 or of the support and locating element 30, preferably of both, to the lightness, tensile strength and modulus of elasticity characteristics of the two connection struts 44 that define the fulcra 46, the measurement cell 4 is able to counteract such impulsive force with an opposite force sufficient for the contacting sphere 51 to take a reduced time, with respect to the known systems, to reverse the moving away motion and touch back the rotating surface S, thus reducing or zeroing the number of bounces and minimizing the time during which the processing unit 5 detects signals that are not indicative of the profile, or of the radial dimensions of the component C.

When the detection phase ends, the measurement cell 4 is brought again by the pneumatic cylinder 60 in the retraction state, as previously described.

Now, the measurement slide 3, appropriately controlled by the processing unit 5, can move the measurement cell 4, which is in the retraction state, along the main direction D, until the contacting sphere 51 is brought at a further known height of a second surface S′ of a further component C′ of the same workpiece W. If the second surface S′ has a profile substantially identical to that of the surface S, a new checking procedure occurs; otherwise, a new calibration procedure may occur with a second master, comprising a reference surface with a reference profile that corresponds to the nominal profile of the second surface S′ to be checked, appropriately located, while rotating, at the further known height.

In addition to what described hitherto, the apparatus 1 may be also applied for measuring linear dimensions, for example diameters. A possible alternative application includes dimensional and/or shape checking of many pieces of the same type, namely pieces that have similar morphology but different nominal dimensions, such as for example journal bearing of various crankshaft or camshaft.

The apparatus 1 for checking dimensional and/or geometric features described hitherto may be modified without departing from the scope of the present invention.

Components having shape and/or dimensions different from those illustrated, for example, may be used. In particular, the support and locating element 30 and the arm 42 may be molded in a way different from that shown in FIG. 2 and the superficial elements may include convenient openings, to further reduce the weight of the measurement cell 4 without modifying its tensile strength.

Possibly, at least one of the support and locating element 30 and the arm 42 may be filled with a material that could absorb collisions and vibrations, for example a thermoplastic polymer such as acrylonitrile butadiene styrene (ABS).

The limitation mechanism 55 and the connection element 59 may be directly connected to the support and locating element 30, or by means of a supporting element integral with said support and locating element 30. Analogously, the locking pin 43 may fasten the arm 42 directly to the support and locating element 30, or fasten the arm 42 to the above-mentioned supporting element or a further supporting element integral with the support and locating element 30.

The pneumatic cylinder 60 may possibly be equipped with a locking ring nut apt to block it in a position wherein the air connection of the pneumatic cylinder 60 can be easier entered.

As an alternative, a different retraction device 60 may be used, for example an asynchronous motor, also controlled by the processing unit 5, that has the advantage of being faster and more accurate with respect to a pneumatic cylinder.

As an alternative, the pencil-head 14 may be substituted by a different transducer device, for example an optical linear scale, preferably laser, the reader thereof is possibly coupled to the checking surface 41 of the arm 42.

An apparatus 1 comprising one or more measurement cells 4 according to the invention may assume many possible configurations, all known per se, different from the configuration of FIG. 1. It may comprise for example more measurement cells 4 fixed to a frame alike the frame 2 and suitably oriented for simultaneously checking the dimensional and/or geometric features of various components C of the same workpiece W, since the number of the measurement cells 4 matches for example the number of the components C to be checked.

1. A checking system, for checking dimensional or geometric features of a workpiece, comprising:
a support and locating element;
a feeler for touching the workpiece to be checked;
a transmission assembly comprising an arm supporting the feeler and movable with respect to the support and locating element; and
a transducer device designed to cooperate with the transmission assembly to detect a position of a checking surface of the arm with respect to the support and locating element and generate corresponding signals indicative of the dimensional or geometric features of the workpiece;
wherein at least one of the support and locating element and the arm is made of a material having density not higher than 1.6 g/cm³ and tensile strength not lower than 1.3 GPa.

2. The checking system according to claim 1, wherein said at least one of the support and locating element and the arm is made of a carbon fiber composite material.

3. The checking system according to claim 1, wherein said at least one of the support and locating element and the arm is defined by a plurality of flat elements connected one to the other.

4. The checking system according to claim 3, wherein said flat elements are glued one to the other at connection edges.

5. The checking system according to claim 3, wherein said flat elements include openings.

6. The checking system according to claim 3, wherein said flat elements are obtained from a sheet of material.

7. The checking system according to claim 3, wherein said flat elements are obtained by a water jet mechanism.

8. The checking system according claim 1, wherein the support and locating element and the arm are both made of said material having density not higher than 1.6 g/cm³ and tensile strength not lower than 1.3 GPa.

9. The checking system according to claim 1, wherein at least one of the support and locating element and the arm is filled with a material able to absorb collisions and vibrations.

10. The checking system according to claim 1, wherein the transmission assembly comprises two connection struts between the arm and a base of the support and locating element, each with two elastic portions that define a fulcrum at each of two opposed connection ends, the base, the arm and the two connection struts forming a parallelogram structure.

11. The checking system according to claim 10, wherein each of the two connection struts comprises a lamina made of a material with a density not higher than 4.4 g/cm³, a tensile strength not lower than 1000 MPa, and a modulus of elasticity not higher than 110 GPa.

12. The checking system according to claim 11, wherein said lamina is a titanium alloy lamina.

13. The checking system according to claim 11, wherein each of said two connection struts includes a flat and stiff portion obtained by coupling backing elements to said lamina in a central zone.

14. The checking system according to claim 13, wherein said backing elements are carbon fiber plates glued to said lamina.

15. An equipment for checking dimensional or geometric features of a workpiece, comprising:
a support and rotation assembly designed to refer and rotate the workpiece about a rotation axis;
at least one checking system according to claim 1; and
a processing unit configured to detect and process the signals generated by the checking system in order to check the dimensional or geometric features of the workpiece.

16. The equipment according to claim 15, further comprising a measurement slide adapted to carry out translation movements in both ways of a main direction parallel to the rotation axis of the workpiece, the processing unit being further adapted to send control signals to the measurement slide to control said translation movements, and said at least one checking system being designed to be coupled to the measurement slide in order to be moved along the main direction.

17. A method for manufacturing a checking system with a support and locating element and an arm, movable with respect to the support and locating element, comprising the steps of:
providing a sheet of material having density not higher than 1.6 g/cm³ and tensile strength not lower than 1.3 GPa;
obtaining a plurality of flat elements from said sheet of material; and
connecting said flat elements one to the other, to obtain box-like structures with substantially rectangular hollow sections that define at least one of said support and locating element and arm.

18. The method according to claim 17, wherein the step of connecting the flat elements includes glueing the flat elements one to the other at connection edges.

19. The method according to claim 17, wherein the step of obtaining a plurality of flat elements from the sheet of material includes cutting the sheet of material using a water jet mechanism.

20. The method according to claim 17, wherein the checking system comprises two connection struts between the arm and a base of the support and locating element, the base, the arm and the two connection struts forming a parallelogram structure.

21. The method according to claim 20, wherein each of the two connection struts includes two elastic portions that define a fulcrum at each of two opposed connection ends.

22. The method according to claim 20, wherein each of said two connection struts includes backing elements obtained from said sheet of material.
